(19) United States
(12) Patent Application Publication
(10) Pub. No.: US 2018/0048530 A1
(43) Pub. Date: Feb. 15, 2018

(54) METHOD AND SYSTEM FOR SUPPORTING DETECTION OF IRREGULARITIES IN A NETWORK

(71) Applicant: NEC EUROPE LTD., Heidelberg (DE)

(72) Inventors: Sofia Nikitaki, Weiterstadt (DE); Maurizio Dusi, Gadesco Pieve Delmona (CR) (IT); Mohamed Ahmed, London (GB); Saverio Niccolini, Heidelberg (DE)

(21) Appl. No.: 15/548,771

(22) PCT Filed: Oct. 23, 2015
(86) PCT No.: PCT/EP2015/074673

§ 371 Date: Aug. 4, 2017

(51) Int. Cl. H04L 12/24; H04L 12/26

(52) U.S. Cl. CPC H04L 41/142; H04L 43/087; H04L 43/0829

(57) ABSTRACT

A method for supporting detection of irregularities in a network includes monitoring features of said network using at least one monitoring device in order to collect spatio-temporal measuring data; providing, in an off-line phase, a training matrix where collected measuring data is aggregated in a predetermined time window such that said training matrix includes spatia-temporal correlations; performing, in said off-line phase, non-negative matrix factorization in order to decompose said training matrix into a coefficient matrix and a basis matrix, wherein temporal correlations and spatial correlations are jointly considered; creating, in an on-line phase; a current runtime matrix on a basis of measuring data newly collected in the on-line phase, computing, in said on-line phase, a current runtime coefficient matrix on a basis of said current runtime matrix and said basis matrix; and comparing, in said on-line phase, said current runtime coefficient matrix with at least one previous coefficient matrix.

### CROSS REFERENCE TO RELATED APPLICATIONS

This application is a U.S. National Stage Application under 35 U.S.C. § 371 of International Application No. PCT/EP2015/074673 filed on Oct. 23, 2015. The International Application was published in English on Apr. 27, 2017 as WO 2017/067615 A1 under PCT Article 21(2).

### STATEMENT REGARDING FUNDING

The work leading to this invention has received funding from the European Union's Seventh Framework Program (FP7/2007-2013) under grant agreement no 318627.

### Field

The present invention relates to a method and a system for supporting detection of irregularities in a network.

### Background

In recent years network operators are actively seeking efficient and accurate solutions to identify performance anomalies and irregularities in their networks and to better understand the evolution in the utilization of their resources by their customers. However, inferring and forecasting the behavior of a network in the presence of heterogeneous network traffic is challenging. Therefore, tools that aid in detecting irregularities in the performance of the network, based on the typical data that is collected by network operators, are much in demand.

For example, the latency of the network is an important measure of quality of service, since popular multimedia services such as video, audio and gaming are latency-sensitive. As such, network operators are interested in understanding when, where and why the latency of the traffic changes and, if possible, they wants to predict these changes in order to pre-empt them to ensure a quality of service required by customers.

Detecting irregularities in network traffic, e.g. due to equipment misconfiguration, failure or by reason of user activity such as changes and/or modifications in the traffic profile of users, is complicated by several factors. Firstly, the size of the data sets that have to be considered can be very large. For example, 1000× of network probes sampling 10-100s variables with a granularity in the seconds are typically possible. It is therefore challenging to efficiently and accurately evaluate the complex temporal and spatial relationships between the measurements. In this regard reference is made e.g. to P. Barford, N. Duffield, A. Ron, J. Sommers: “Network Performance Anomaly Detection and Localization”, INFOCOM 2009: pp. 1377, 1385, 19-25 Apr. 2009.

Traditional network performance mining and analysis struggles to cope with the scale of data from networks and number of features which have to be considered. Methods and systems as described in Y. Zhou, G. Hu, D. Wu: “A data mining system for distributed abnormal event detection in backbone networks”, Security and Communication Networks, Volume 7, Issue 5, pages 904-913, May 2014 and as described in H. Madhyastha, E. Katz-Bassett, T. Anderson, A. Krishnamurthy, and A. Venkataramani: “iPlane Nano: Path Prediction for Peer-to-Peer Applications”, NSDI, page 137-152, USENIX Association, 2009 focus on the detection of changes to a single network probe without considering that events in the network may be strictly correlated, i.e. a congestion that is observed on an intermediate hop is likely to propagate on following hops.

Traditional anomaly detection systems tend to assume that traffic distributions are close to a constant with sporadic bursts over time, and identify anomalies by computing the correlation between pairs of points to define outliers as described e.g. in H. Kriegel, M. Schubert, and A. Zimek: “Angle-based outlier detection”, In Proc. ACM SIGKDD Int. Conf on Knowledge Discovery and Data Mining (SIGKDD) Las Vegas Nev., 2008. While the known system accounts for temporal correlations, it fails to identify regular outliers that tend to occur as part of a daily pattern. For example, a sudden burst of latency might appear every day at a specific network probe due to maintenance schedules. Obviously, this should not be considered as an anomaly because it follows a daily pattern.

Furthermore, it is exemplarily referred to the following non-patent literature: A. Nagata, K. Kotera, K. Nakamura, Y. Hori: “Behavioral Anomaly Detection System on Network Application Traffic from Many Sensors”, Computer Software and Applications Conference (COMPSAC), 2014 IEEE 38th Annual, pp. 600, 601, 21-25 Jul. 2014, Peng C, Jin X, Wong K-C, Shi M, Lio P: “Collective Human Mobility Pattern from Taxi Trips in Urban Area” PLoS ONE 7(4): e34487. doi:10.1371/journal.pone.0034487, 201, and H. Huang, H. Al-Azzawi, and H. Brani: “Network traffic anomaly detection”, ArXiv:1402.0856v1, 2014 tall deal with non-negative matrix factorization (NMF) techniques that are applied in order to detect anomalies in traffic. As these approaches consider spatial and temporal correlations in the data independently, they fail to estimate stable normal basis patterns. Therefore, they are unable to accurately capture the behaviors observed in the data.

Matrix factorization (MF) is a state of the art method to capture complex behaviors. Matrix factorization techniques are based on the observation that when data is correlated, it has a low-rank property, i.e. only a small number of the features can capture/reproduce the data with low error. In order to identify outliers, the difference between the sampled data and their normal subspace, i.e. the low-rank approximation, is computed and the strength of the difference highlights the impact of the outlier. However, traditional matrix factorization techniques, such as singular value decomposition (SVD), account for the spatial patterns appeared in the network data, but they do not consider the temporal correlations in the sense that reordering the data in time has no effect on the results.

### SUMMARY

In an embodiment, the present invention provides a method for supporting detection of irregularities in a network. The method includes monitoring features of said network using at least one monitoring device in order to collect spatio-temporal measuring data; providing, in an off-line phase, a training matrix where collected measuring data is aggregated in a predetermined time window such that said training matrix includes spatio-temporal correlations; performing, in said off-line phase, non-negative matrix factorization in order to decompose said training matrix into a coefficient matrix and a basis matrix, wherein temporal correlations and spatial correlations are jointly considered; creating, in an on-line phase, a current runtime matrix on a basis of measuring data newly collected in the on-line phase; computing, in said on-line phase, a current runtime coefficient matrix on a basis of said current runtime matrix and said basis matrix; and comparing, in said on-line phase, said current runtime coefficient matrix with at least one coefficient matrix that was computed previously.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view illustrating a non-negative matrix factorization technique that may be used in a method and a system according to embodiments of the present invention;

FIG. 2 is a schematic view illustrating an architectural overview of a method or a system according to embodiments of the present invention; and

FIG. 3 is a schematic view illustrating an exemplary system architecture according to an embodiment of the present invention.

### DETAILED DESCRIPTION

Embodiments of the present invention provide a method for supporting detection of irregularities in a network in such a way that performance anomalies can be detected more efficiently and accurately in the network.

According to an embodiment of the invention, a method is provided that includes: monitoring features of said network using at least one monitoring device in order to collect spatio-temporal measuring data, providing, in an off-line phase, a training matrix where collected measuring data is aggregated in a predetermined time window such that said training matrix includes spatio-temporal correlations, performing, in said off-line phase, non-negative matrix factorization in order to decompose said training matrix into a coefficient matrix and a basis matrix, wherein temporal correlations and spatial correlations are jointly considered, creating, in an on-line phase, a current runtime matrix on the basis of measuring data newly collected in the on-line phase, computing, in said on-line phase, a current runtime coefficient matrix on the basis of said current runtime matrix and said basis matrix, and comparing, in said on-line phase, said current runtime coefficient matrix with at least one coefficient matrix that was computed previously.

According to an embodiment of the invention, a system for supporting detection of irregularities in a network is provided, the system including one or more monitoring devices, an off-line component and an on-line component, wherein said monitoring devices are configured to monitor features of said network in order to collect spatio-temporal measuring data, wherein said off-line component is configured to provide a training matrix where collected measuring data is aggregated in a predetermined time window such that said training matrix includes spatio-temporal correlations, wherein said off-line component is further configured to perform non-negative matrix factorization in order to decompose said training matrix into a coefficient matrix and a basis matrix, wherein temporal correlations and spatial correlations are jointly considered, wherein said on-line component is configured to create a current runtime matrix on the basis of measuring data newly collected in the on-line phase, wherein said on-line component is further configured to compute a current runtime coefficient matrix on the basis of said current runtime matrix and said basis matrix, and wherein said on-line component is further configured to compare said current runtime coefficient matrix with at least one coefficient matrix that was computed previously.

Real network data presents a strong temporal correlation due to the periodic behavior of users. Underlying spatial correlation may appear because monitoring devices such as network probes close in space tend to capture related phenomena such as, for example, burst in traffic or the after effect of misconfiguration. According to embodiments of the invention at least one monitoring device monitors features of a network in order to collect spatio-temporal measuring data. In an off-line phase a training matrix is generated where collected measuring data is aggregated in a predetermined time window such that said training matrix includes spatio-temporal correlations in its measuring data. Further it has been recognized that spatio-temporal matrix factorizations are able to better capture complex hidden patterns within the measuring data and, therefore, can improve the accuracy and efficiency of network performance debugging and the optimization. According to embodiments of the invention a non-negative matrix factorization is performed in the off-line phase in order to decompose the training matrix into a coefficient matrix and a basis matrix, wherein the temporal correlations and the spatial correlations in the training matrix are jointly considered. The basis matrix represents underlying basis patterns of the measuring data of the training matrix. The coefficient matrix represents the strength of the individual underlying basis patterns. In an on-line phase, a current runtime matrix is created on the basis of measuring data newly collected in the on-line phase. Thus, the current runtime matrix includes measuring data about features within the network that are monitored by the monitoring devices. In the on-line phase, a current runtime coefficient matrix is computed on the basis of the current runtime matrix and the basis matrix that was computed in the off-line phase. This current runtime coefficient matrix is compared with at least one coefficient matrix that was computed previously, so that on the basis of the comparison irregularities in the network can be deduced. The coefficients matrix's components may represent the strength corresponding to the underlying basis patterns that are represented by the basis matrix, wherein the strength of each underlying basis pattern can be tracked over time and space. Thus, the method and the system according to the invention enable that performance anomalies/irregularities can be detected more efficiently and accurately in the network.

A method and a system according to the invention are motivated by the finding that network data present strong correlations and a reduced number of traffic patterns as basis patterns can capture the structure of the whole network behavior. In contrast to known approaches, a method and a system according to the present invention can exploit the strength of the presence of each basis pattern in order to infer the behavior of each monitoring device in a given point in time and refer the associate changes.

Hence, a method is based on a non-negative matrix factorization approach and accounts for the inherent correlation structure of network measuring data both in time and space. This enables the construction of stable basis patterns (e.g. global traffic patterns) that capture more accurately the underlying behavior of the network. Hence, the method and system according to the invention are able to changes in observed network data in order to increase the efficiency of the network management and fault-handling.

According to embodiments of the invention, the process of the on-line phase may be performed periodically. Thus, the on-line component may detect changes of the basis patterns concerning network observations in real-time.

According to embodiments of the invention, the non-negative matrix factorization for computing the coefficient matrix and the basis matrix may be performed on the basis of an objective function, in particular a cost function, in the off-line phase. By doing this, the problem of characterizing the behavior of the network is formulated as a non-negative matrix factorization (NMF) problem, wherein dependent on the objective function the hidden structure in the measuring data can be identified such that stable basis patterns capturing behaviors observed in the data are built.

According to embodiments of the invention, the objective function may impose spatial and temporal constraints on the non-negative matrix factorization such that temporal correlations and spatial correlations in the collected measuring data are considered. Thus, the detection of performance anomalies/irregularities in the network is improved in an efficient way and enables more accurate results.

According to embodiments of the invention, the training matrix may be defined as a matrix X^{tr} ∈ R^{N}^{^{L}}^{×M}, wherein N^{L} represents the number generated by N monitoring devices and L features, and wherein M represents the number of time samples. For instance, if each monitoring device observes L features, then the training matrix will have N·L rows. Furthermore, the measuring data of the training matrix X^{tr} may be aggregated in a predetermined time window, e.g. minutes, hours, etc. Advantageously, the length of the time window is defined in a suitable way with respect to the respective application setting.

According to embodiments of the invention, the objective function may be defined as follows:

min{∥X^{tr}−UV^{T}∥_{F}²+α(∥U∥_{F}²+∥V∥_{F}²)+β(∥S(UV^{T})∥_{F}²+∥(UV^{T})T∥_{F}²)}.

wherein U ∈ R^{N}^{^{L}}^{×k} is the coefficient matrix, wherein V/∈/R^{M×k} is the basis matrix, wherein k is a number of different underlying basis patterns, wherein α is a norm regularization coefficient, wherein β is a spatio-temporal regularization coefficient, wherein S ∈ R^{N}^{^{L}}^{×N}^{^{L}} is a spatial matrix that holds spatial constraints, and wherein T ∈ R^{M×M} is a temporal matrix that holds temporal constraints. Furthermore, the objective function uses the Frobenius norm. Thus, by using the objective function, stable basis patterns can be built, wherein these basis patterns accurately capture behaviors observed in the measuring data of the training matrix.

According to embodiments of the invention, the spatial matrix may be an adjacency matrix of the topology of said network. Thus, the correlations between the rows, i.e. the spatial correlations, may be captured.

According to embodiments of the invention, the temporal matrix may be a Toeplitz matrix. Thus, the temporal smoothness of the collected measuring data may be captured by the Toeplitz matrix.

According to embodiments of the invention, a stochastic gradient descent (SGD) procedure, in particular a distributed stochastic gradient descent (DSGD) procedure, may be employed in order to compute a solution of the objective function. Embodiments of the invention may introduce constraints in the optimization problem in order to capture the combined consideration of the spatial and temporal correlations in the measuring data and is able to capture when and where changes in the network occur. Advantageously, a distributed stochastic gradient decent procedure may be used in order to compute a solution of the objective function. Thus, the scalability may be ensured, because this procedure has good convergence guarantees and can be easily parallelized, so that more features and datasets can be considered. DSGD is simple and computationally lightweight containing only vector-wise operators. An exemplary implementation of DSGD is described in R. Gemulla, P. Haas, E. Nijkamp, Y. Sismanis: “Large-Scale Matrix Factorization with Distributed Stochastic Gradient Descent”, KDD 2011.

According to embodiments of the invention, the current runtime coefficient matrix may be computed by projecting the current runtime matrix onto the basis matrix. Thus, the current runtime coefficient matrix can be computed/estimated in order to be compared with one or more previous coefficient matrices.

According to embodiments of the invention, the current runtime coefficient matrix may be compared in the on-line phase with a coefficient matrix that was computed in any of the previous time intervals by computing the difference between the matrices.

According to embodiments of the invention, an anomalous change/irregularities within the network may be detected and/or triggered, if the computed difference is above a predefined threshold. Thus, a suitable threshold may be defined that enables the trigger for anomalous changes/irregularities in the network.

According to embodiments of the invention, the features for constructing the training matrix and the current runtime matrix may include latency, jitter and/or packet loss, in particular between pairs of links in the network. Thus, correlation structures may be identified over time and space between features that are commonly monitored by network measurement probes. By doing this, anomalous activity in the network traffic may be identified for the purpose of performance anomaly detection and for the characterization of the evolution of the network's behavior.

According to embodiments of the invention, the measurement time granularity of features measured in the on-line phase for creating the current runtime matrix may be chosen such that this granularity is compatible with the measurement time granularity chosen in the off-line phase. Thus, optimal results may be obtained.

According to embodiments of the invention, the stability of underlying basis patterns may be captured by one or more statistical properties of the sampled measuring data, in particular by average, variance and/or quantile. Thus, given multiple training matrices over the same region, a set of basis patterns which is stable over time can be estimated.

Embodiments of the invention define a scalable system for identifying complex changes in the regular patterns of activity in data, in particular in network data. A method and/or a system may be applied to identifying anomalous activity in network traffic for the purpose of performance anomaly detection and for the characterization of the evolution of the network's behavior.

Embodiments of the invention provide a method or a system for identifying the complex correlation structures over time and space between features that are commonly monitored by network measurement probes. The collected data may refer to captured latency, jitter, packet loss etc. These correlations can then be exploited to characterize the evolution of a network link's properties, such as the expected fluctuations in its latency over a given day, and assess whether deviations from it are anomalous with respect the normal expected behavior. The computational complexity of the proposed method is linear in the number of training samples. However, recent theoretical results in large-scale data show that the runtime to get the desired optimization accuracy does not increase as the training set size increases, cf. e.g. Leon Bottou: “Large-Scale Machine Learning with Stochastic Gradient Descent” in COMPSTAT 2010—Proceedings of the 19th International Conference on Computational Statistics, pages 177-187, 2010.

Furthermore, strong temporal correlations in network performance may appear due to many reasons, e.g. including the periodic and habitual behaviors of users, and the actions of automated tools such as configuration and policy update tools. While the directed link structure of network topologies, and the geographical proximity that is associated with them, may induce spatial correlations in traffic measurements.

As opposed to the current state of the art, embodiments of the present invention can be based on a non-negative matrix factorization approach and accounts for the inherent correlation structure of network data both in time and space. This enables the construction of stable global traffic patterns that capture more accurately the underlying behavior of the network. Hence, shifts in observed network data can be detected in order to increase the efficiency of the network management and fault-handling.

Furthermore, at least one embodiment of the present invention may be solved via stochastic gradient descent that can be distributed and thus making it appropriate for large-scale learning data.

According to the invention, a joint spatio-temporal matrix factorization can be provided that jointly accounts for the correlations over different traffic measurements between monitoring devices, such as network probes, over time. To this aim, different kind of information is integrated into the spatio-temporal matrix factorization process which allows uncovering the basis patterns such as the common network traffic patterns in the training matrix as indicated by multiple features.

According to the invention, the strength of the coefficients of the basis matrix can be exploited for monitoring the network behavior in a specific area, topological or geographical, and its changes over time in order to infer where and when a change in the network happens. This allows for monitoring the evolution of network's behavior in specific probes over time.

Embodiments of the invention provide a system or a method to jointly exploit the inherent spatio-temporal correlations in the measuring data in order to build stable basis patterns that accurately capture behaviors observed in the measuring data. Stable basis patterns may be defined such that their estimation will not diverge as the sampling data measured in the on-line phase evolve over time. The reason why stable bases are created over time is that the efficiency of anomaly detection techniques depends in estimating significant differences between the captured measuring data and the basis patterns created from historical observations. Thus, stability can be viewed as a form of prior knowledge about the captured spatio-temporal measuring data and it is expected that their patterns remain bounded over time. As such, in general the proposed approach can be applied to detect patterns in a variety of spatio-temporal data, such as revealing the underlying patterns in the mobility of people and vehicles in urban spaces, and the consumption of resources such as in electrical grids. Additionally, the proposed method is suitable for identifying changes in electrical power consumption of commercial buildings. Detecting changes in energy consumption data collected by power meters from several buildings may hint device failures of critical technical infrastructure. Embodiments of the present invention may be applied to any computer networks or data networks that provide, generate and/or exchange spatio-temporal data.

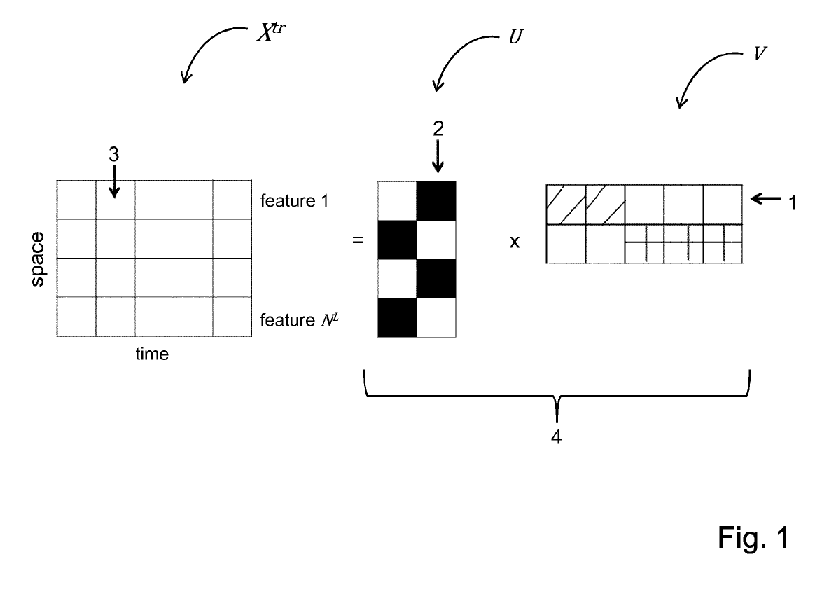

FIG. 1 shows a non-negative matrix factorization (NMF) that may be used in a method and a system according to an embodiment of the present invention. The method or system according to an embodiment of the present invention detects the changes from network measurements based on global traffic patterns, i.e. basis patterns, created from historical observations. The problem of characterizing the behavior of the network is formulated as a non-negative matrix factorization problem. Non-negative matrix factorization considers a matrix of non-negative observed data and explains the observations as a linear combination of the features specified in the matrix. More specifically, as shown in FIG. 1, non-negative matrix factorization solves an optimization problem in order to decompose an input matrix such as a traffic matrix, namely e.g. the training matrix X^{tr}, into a basis matrix V and a coefficient matrix U. According to FIG. 1 the basis matrix V represents the normal subspaces or latent factors, i.e. the underlying basis patterns in the measuring data, and the components/columns of the coefficient matrix U represent the strength of these latent factors. Each row of the training matrix X^{tr} represents a feature that was monitored by a predetermined measuring probe. Each column represents different time samples of the respective feature.

By using the a non-negative matrix factorization as exemplarily depicted in FIG. 1, the training matrix X^{tr} in the form of an traffic matrix is decomposed into two matrices, namely the coefficient matrix U and basis matrix V. Each line in the basis matrix V represents a basis pattern. Each column of the coefficient matrix U represents the power corresponding to each of the basis patterns. Thus, the coefficients matrix's components represent the strength corresponding to the underlying basis patterns that are represented by the basis matrix. In FIG. 1 reference sign 1 shows a basis pattern of the basis matrix V. Reference sign 2 shows a column of the coefficient matrix U, wherein the column 2 represents the power reflecting the strength of the basis patterns. Reference sign 3 shows a feature monitored by a network measuring probe at a specific time. Reference sign 4 shows the decomposition of the training matrix X^{tr}.

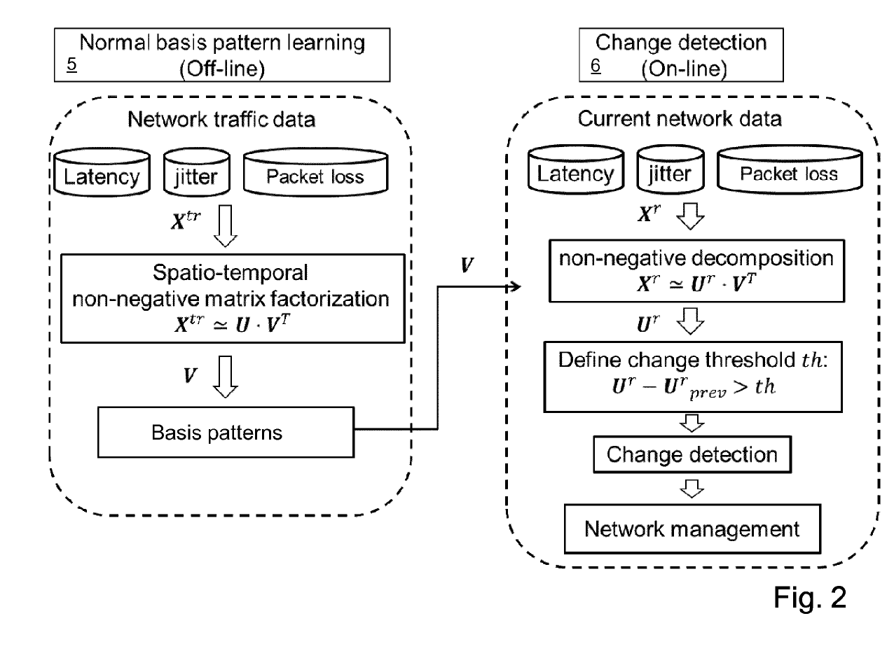

FIG. 2 shows an architectural overview of a method and a system according to an embodiment of the present invention. The system of FIG. 2 is composed of two components: an off-line component, reference sign 5, which is charged with learning the underlying basis patterns in the measuring data, and an on-line component, reference sign 6, for running the basis patterns learned in the off-line phase in order to detect changes/irregularities in the measuring data currently measured in the on-line phase.

The off-line component performs a normal basis pattern learning as depicted in FIG. 2 such that in the off-line phase a basis matrix V is built based on a training matrix X^{tr} as follows:

Defining a training matrix X^{tr} ∈ R^{N}^{^{L}}^{×M} where data are aggregated in a given time window, i.e. e.g. minutes, hours, etc. For example, in case of network performance monitoring, N represents the number of probes, L the number of features and M the number of time samples. For example, the training matrix X^{tr} can be constructed from measurements of the latency or jitter between pairs of links. The length of the time window is defined with respect to the particular application setting.

Factorizing the training matrix X^{tr} with a spatial-temporal regularization, wherein an objective function for the non-negative matrix factorization is defined as follows:

min{∥X^{tr}−UV^{T}∥_{F}²+α(∥U∥_{F}²+∥V∥_{F}²)+β(∥S(UV^{T})∥_{F}²+∥(UV^{T})T∥_{F}²)} (1)

where U ∈ R^{N}^{^{L}}^{×k} and V ∈ R^{M×k} are the coefficient and basis matrices and k defines the number of different basis patterns. α is the norm regularization coefficient and β the spatio-temporal regularization coefficient that need to be tuned empirically, in particular by cross-validation. The terms, S ∈ R^{N}^{^{L}}^{×N}^{^{L}} and T ∈ R^{M×M} give the spatial and temporal constraints respectively. Different methods can be applied in order to estimate the matrices S and T.

For example, the correlations between the rows of the training matrix X^{tr}, i.e. spatial correlations, may be captured by deriving the adjacency matrix of the weighted graph created from matrix X^{tr} or the network topology. Additionally, it may be any arbitrary cost matrix that characterizes the data set.

The temporal correlations are represented by matrix T that imposes the correlations between the different time samples. For example, matrix T can be the Toeplitz matrix that captures the temporal smoothness of the collected data and enforces it.

A stochastic gradient descent (SGD) is applied in order to solve the objective function according to formula (1). SGD has three distinct features as a) it requires neither explicit constructions of matrices nor central servers where measurements are processed, b) it is simple and computationally lightweight containing only vector-wise operators and c) it can be parallelized thus allowing for the scalability of the technique. Further information can be found in Leon Bottou: “Large-Scale Machine Learning with Stochastic Gradient Descent” in COMPSTAT 2010—Proceedings of the 19th International Conference on Computational Statistics, pages 177-187, 2010.

Given multiple training matrices over the same region, a set of basis patterns which is stable over time may be estimated, namely in the form of the basis matrix V. For example, the stability of the matrix may be captured with statistical properties of the sampled data such as the average and the variance, quantiles or variance.

Storing basis matrix V and coefficient matrix U.

The on-line component performs change and anomaly detection as depicted in FIG. 2 in order to detect irregularities in the network. The objective of the on-line component is to detect the changes of the basis patterns of observations in real-time. The steps of the on-line process illustrated in FIG. 2 and which are periodically performed in the on-line phase are as follows:

Collecting periodic measurement of the data and creating a current runtime matrix X^{r}. For example, the current runtime matrix X^{r} can be constructed from measurements of the latency or jitter between pairs of links. In doing so the measurement time granularity should be compatible with the one chosen in the off-line phase.

Projecting the current runtime matrix X^{r} onto the basis matrix V in order to compute the current runtime coefficient matrix U^{r}.

The difference of the strength between the current coefficients of U^{r} and of U^{r} prev, i.e. the ones estimated in previous time intervals and/or during the off-line phase indicates whether there has been a change in the normal underlying basis patterns for each feature.

A change and/or irregularity in the network behavior is triggered, if the difference is above a predefined threshold.

The embodiment of FIG. 2 introduces constraints in the optimization problem in order to capture the jointly consideration of the spatial and temporal correlations in the data, and is able to capture when and where changes occur. For enabling the scalability of the approach illustrated in FIG. 2, the objective function according to formula (1) is solved by means of a distributed stochastic gradient descent technique which has good convergence guarantees and can be easily parallelized, such that more features and data sets can be considered.

Once the stable basis patterns in form of the basis matrix V are computed, they can be used to identify changes in patterns observed in data. In particular, the weight of each identified pattern in the data can be tracked over time and space, and (i) rank the activity of each pattern, at given period of time, or at a particular location, and (ii) identify when and where significant changes occur in each pattern.

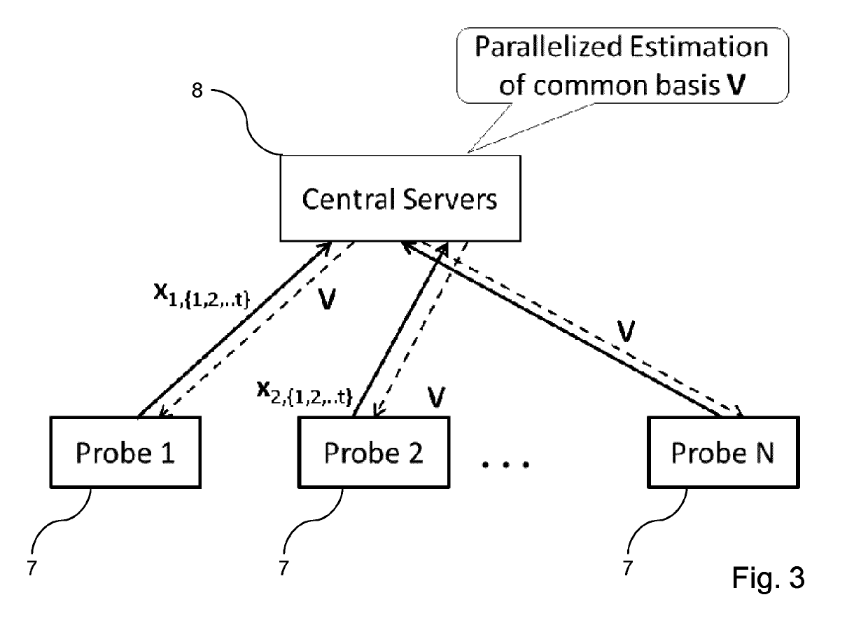

FIG. 3 shows an exemplarily system architecture according to an embodiment of the present invention. During the off-line phase each probe i, reference sign 7, sends the features X_{i,{1, . . . , t}} captured over time interval {1, . . . , t} to an off-line component. The off-line component may be implemented on one or more central servers, reference sign 8. Hence, in cases the off-line component comprises several central servers, the servers run in a parallel way the spatio-temporal non-negative matrix factorization in order to estimate the common basis matrix V. The off-line component or, as the case may be, the central servers send back the common basis matrix V to the probes.

A further embodiment may provide a method for identifying the complex correlation structures over time and space between features that are commonly monitored by network measurement probes such as latency, jitter, and packet loss comprising the following steps: Off-line-phase: Defining a training matrix X^{tr} ∈ R^{N}^{^{L}}^{×M} where data are aggregated in a given time window. Defining the matrices S ∈ R^{N}^{^{L}}^{×N}^{^{L}} and T ∈ R^{M×M} that hold the spatial and temporal constraints respectively. The matrix S defines the correlations between the rows of the training matrix X^{tr} and could be the adjacency matrix of the topology of the network. The temporal correlations are defined via matrix T. Matrix T could be the Toepliz matrix. Define the basis matrix V by factorizing the matrix X^{tr} by solving the formula (1).

On-line-phase: Creating the matrix X^{r} from the on-line captured data. Projecting the on-line data X^{r} onto the basis matrix V in order to estimate the runtime coefficient matrix U^{r}. Defining a change threshold th, above which the difference between the current coefficients of U^{r} and the previous time intervals indicate a change/irregularity. Estimating the difference between the current runtime coefficient matrix and the previous.

At least one of the embodiments may impose the inherent spatio-temporal correlation structure of the sampled data in order to accurately and efficiently identify the hidden structure in the data. The proposed approach can identify commonality and trends in data and additionally is able to cross-correlate numerous features, identify and remove redundant information.

At least one of the embodiments was validated with real traffic data collected from a network operator over a period of three months with sampling granularly of 60 seconds. To this extent, it was focused on two different features: latency and jitter.

According to that, embodiments of the invention may create more stable global basis patterns because they are able to minimize the reconstruction error of the current traffic patterns and the global ones in the order of 8%, while traditional non-negative matrix factorization returns an error in the order of 35% as may be obtained from the following table:

| Number of training sets used for | | |
|---|---|---|
| training in the off-line phase | Normalized Reconstruction Error | |
| (1 set is collected over 30 days) | Traditional NMF | Temporal NMF |
| 1 | 0.431 | 0.09 |
| 2 | 0.35 | 0.08 |

The table above shows a normalized reconstruction error between the global and the current basis for the traditional NMF approach and the spatio-temporal NMF according to an embodiment of the present invention. The stable basis patterns were computed for features latency and jitter sampled over a period of three months. The table shows that as the number of training sets increases the reconstruction error decreases. Embodiments of the present invention are able to create more stable global basis patterns compared to traditional NMF.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for supporting detection of irregularities in a network, the method comprising:
monitoring features of said network using at least one monitoring device in order to collect spatio-temporal measuring data,
providing, in an off-line phase, a training matrix where collected measuring data is aggregated in a predetermined time window such that said training matrix includes spatio-temporal correlations,
performing, in said offline phase, non-negative matrix factorization in order to decompose said training matrix into a coefficient matrix and a basis matrix, wherein temporal correlations and spatial correlations are jointly considered,
creating, in an on-line phase, a current runtime matrix on a basis of measuring data newly collected in the on-line phase,
computing, in said on-line phase, a current runtime coefficient matrix on a basis of said current runtime matrix and said basis matrix, and
comparing, in said on-line phase, said current runtime coefficient matrix with at least one coefficient matrix that was computed previously.

2. The method according to claim 1, wherein said non-negative matrix factorization for computing said coefficient matrix and said basis matrix is performed on a basis of a cost function.

3. The method according to claim 2, wherein said cost function imposes spatial and temporal constraints on the non-negative matrix factorization such that temporal correlations and spatial correlations in the collected measuring data are considered.

4. The method according to claim 1, wherein said training matrix is defined as a matrix X^{tr} ∈ R^{N}^{^{L}}^{×M}, wherein N^{L} represents the number generated by N monitoring devices and L features, and wherein M represents the number of time samples.

5. The method according to claim 2, wherein said objective function is defined according to
min{∥X^{tr}−UV^{T}∥_{F}²+α(∥U∥_{F}²+∥V∥_{F}²)+β(∥S(UV^{T})∥_{F}²+∥(UV^{T})T∥_{F}²)},
wherein U ∈ R^{N}^{^{L}}^{×k} is said coefficient matrix, wherein V ∈ R^{M×k} is said basis matrix, wherein k is a number of different basis patterns, wherein ex is a norm regularization coefficient, wherein β is a spatio-temporal regularization coefficient, wherein S ∈ R^{N}^{^{L}}^{×N}^{^{L}} is a spatial matrix representing spatial constraints, and wherein T ∈ R^{M×M} is a temporal matrix representing temporal constraints.

6. The method according to claim 5, wherein said spatial matrix is an adjacency matrix of a topology of said network,

7. The method according to claim 5, wherein said temporal matrix is a Toeplitz matrix.

8. The method according to claim 2, wherein a distributed stochastic gradient descent, procedure, is employed in order to compute a solution of said objective function.

9. The method according to claim 1, wherein said current runtime coefficient matrix is computed by projecting said current runtime matrix onto said basis matrix.

10. The method according to claim 1, wherein said current runtime coefficient matrix is compared with a previously computed coefficient matrix by computing the difference therebetween.

11. The method according to claim 10, wherein an anomalous change and/or irregularity will be detected and/or triggered, if the computed difference is above a predefined threshold.

12. The method according to claim 1, wherein said features for constructing said training matrix and said current runtime matrix include latency, jitter and/or packet loss, between pairs of links in said network.

13. The method according to claim 1, wherein measurement time granularity of the features measured in the on-line phase for creating said current runtime matrix is compatible with measurement time granularity chosen in the off-line phase,

14. The method according to claim 1, wherein the stability of basis patterns is captured by one or more statistical properties of sampled measuring data, in particular by average, variance and/or quantile.

15. A system for supporting detection of irregularities in a network, the system comprising:
one or more monitoring devices;
an off-line component; and
an on-line component,
wherein said monitoring devices are configured to monitor features of said network in order to collect spatio-temporal measuring data,
wherein said off-line component is configured to provide a training matrix where collected measuring data is aggregated in a predetermined time window such that said training matrix includes spatio-temporal correlations,
wherein said off-line component is further configured to perform non-negative matrix factorization in order to decompose said training matrix into a coefficient matrix and a basis matrix, wherein temporal correlations and spatial correlations are jointly considered,
wherein said on-line component is configured to create a current runtime matrix on a basis of measuring data newly collected in the on-line phase,
wherein said on-fine component is further configured to compute a current runtime coefficient matrix on the-a basis of said current runtime matrix and said basis matrix, and
wherein said on-line component is further configured to compare said current runtime coefficient matrix with at least one coefficient matrix that was computed previously.
